(19) United States
(12) Patent Application Publication
(10) Pub. No.: US 2017/0024673 A1
(43) Pub. Date: Jan. 26, 2017

(54) COMPUTER-READABLE STORAGE MEDIUM, DISPLAY INFORMATION CONTROL METHOD, AND DISPLAY INFORMATION CONTROL DEVICE

(71) Applicant: FUJITSU LIMITED, Kawasaki-shi (JP)

(72) Inventor: Takao Toshima, Yokohama (JP)

(73) Assignee: FUJITSU LIMITED, Kawasaki-shi (JP)

(21) Appl. No.: 15/214,572

(22) Filed: Jul. 20, 2016

(30) Foreign Application Priority Data
Jul. 23, 2015 (JP) 2015-146108

(51) Int. Cl. G06Q 10/06; G06F 3/0482

(52) U.S. Cl. CPC G06Q 10/06316; G06F 3/0482

(57) ABSTRACT

A display information control method including displaying a plurality of display items corresponding to a first task based on a predetermined priorities for each of the plurality of display items when at least one task has been executed according to a predetermined order before an execution of the first task in a process, determining a priorities for each of the plurality of display items when the at least one task has been executed according to an order different from the predetermined order, the determining including making a priority for a specified display item to be higher than priorities for the plurality of display items for the first task other than the specified display item, the specified item being a display item accepting an input in the at least one task, and displaying the plurality of display items based on the determined priorities.

### CROSS-REFERENCE TO RELATED APPLICATION

This application is based upon and claims the benefit of priority of the prior Japanese Patent Application No. 2015-146108, filed on Jul. 23, 2015, the entire contents of which are incorporated herein by reference.

### FIELD

The embodiment discussed herein is related to a non-transitory computer-readable storage medium, a display information control method, and a display information control device.

### BACKGROUND

In related art, there has been a technique that sets a search condition for searching for a requested reference data from plural reference data by referring to history data of search conditions used in the past, searches for the requested reference data from the plural reference data in accordance with the set search condition, and thereby displays the result of the search.

Further, there has been a technique that executes a processing in accordance with an operation received from a user, sets a workflow to become usable based on history information which includes processing identification information of a processing which is executed in the past, and thereby selects and sets a workflow which is highly frequently used.

As an example of related art, Japanese Laid-open Patent Publication No. 10-187840 and No. 2010-50786 are known.

### SUMMARY

According to an aspect of the invention, a non-transitory computer-readable storage medium that stores a display information control program that causes a computer to execute a processing including displaying a plurality of display items corresponding to a first task based on a predetermined priorities for each of the plurality of display items when at least one task has been executed according to a predetermined order before an execution of the first task in a process, the first task and the at least one task being defined to be executed in the process, determining a priorities for each of the plurality of display items when the at least one task has been executed according to an order different from the predetermined order before the execution of the first task in the process, the determining including making a priority for a specified display item to be higher than priorities for the plurality of display items for the first task other than the specified display item, the specified item being a display item accepting an input in the at least one task, and displaying, after the determining, the plurality of display items corresponding to the first task based on the determined priorities.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates one example of a process;

FIG. 2 is a diagram that illustrates one example of an article purchase flow;

FIG. 3 is a diagram that illustrates a configuration of a display information control system according to this embodiment;

FIG. 4 is a diagram that illustrates one example of a process information list;

FIG. 5 is a diagram that illustrates one example of a task information list;

FIG. 6 is a diagram that illustrates one example of an input screen information list;

FIG. 7 is a diagram that illustrates one example of a display priority information list;

FIG. 8 is a diagram that illustrates one example of a process execution history list;

FIG. 9 is a diagram that illustrates one example of a word correspondence list;

FIG. 10 is a block diagram that illustrates a functional configuration of a display information control device according to this embodiment;

FIG. 11 is a diagram that illustrates one example of a subject process execution history list;

FIG. 12 is a diagram that illustrates one example of a path selection execution history list;

FIG. 13 is a diagram that illustrates one example of an uncorrected display order of input items;

FIG. 14 is a diagram that illustrates one example of a corrected display order of input items;

FIG. 15 is a block diagram that illustrates a schematic configuration of a computer that functions as the display information control device according to this embodiment;

FIG. 16 is a flowchart that illustrates one example of a display information control processing in the display information control device according to this embodiment;

FIG. 17 is a flowchart that illustrates one example of a correction processing in the display information control device according to this embodiment; and

FIG. 18 is a flowchart that illustrates one example of an update processing in the display information control device according to this embodiment.

### DESCRIPTION OF EMBODIMENT

In various business fields, business process management (BPM) products are used for managing workflows. It is desirable that the BPM products display information that is requested when a user performs decision-making in an appropriate display order on a processing screen of each task included in a workflow.

Requested information may be different in accordance with kinds of tasks and users that process tasks. Thus, as the above related art, it is possible to use statistical data (history information) to customize the display order of items on the processing screen.

However, differently from an ordinary path of tasks (a flow to a task concerned), there may be a case where on the processing screen in an abnormal path in which returning of a processing or the like is performed, items may be desired to be displayed in the display order that takes into account the reason why the abnormal path is selected. In the above related art, regardless of the reason why the abnormal path is selected, items of the processing screen of the task are displayed in a standard display order based on statistical data.

It is desired to indicate items on a processing screen of a task in an appropriate display order in a case where the task is in an abnormal path.

An embodiment will hereinafter be described. First, an outline of this embodiment will be described.

In recent years, business process management (BPM) products are used for managing workflows in various business fields.

The BPM products have characteristics that a workflow is fundamentally freely remodeled and a path represented by a sequence of tasks included in the workflow is newly created.

Further, it is desirable that the BPM products indicate an optimal user interface (UI) for each business in order to smoothly carry out a business based on use of workflows.

Further, because the arrangement, order, and so forth of tasks are remodeled by the user in a workflow system, the display priority order of the UI is desired to correspond to the remodeling. Specifically, in the BPM product, the processing screen of each task is caused to be automatically generated as or changed to an optimal UI for each business in a case where the workflow is remodeled.

However, information that is requested when the user performs decision-making is different in accordance with kinds of tasks and users that execute tasks. Further, differently from an ordinary path of tasks, various reasons for selection of a path are possible about an abnormal path in which returning or the like is performed.

Thus, in the BPM product, a display information control device according to this embodiment rearranges pieces of information to be displayed such that a piece of information that is requested when the user performs decision-making is displayed at a higher level as an input item.

Further, the display information control device according to this embodiment changes the display in accordance with the difference in the paths to the task even if the processing screen displays the same task, in a case where the pieces of information to be displayed are rearranged. In this case, the pieces of information to be displayed are rearranged by using statistical data in which paths are associated with pieces of information that are referred to on the processing screens of respective tasks.

In addition, the display information control device according to this embodiment changes pieces of information to be displayed for a task in an abnormal path in accordance with input or processed contents in a task in a path in the past, in a case where the pieces of information to be displayed are rearranged.

Specifically, in a workflow managed by a system, the processing screen of each task is associated with the user who processes the task, the path that leads to the task, and the information input (here, inputting includes reference, change, and update) on the processing screen of the task and thereby is accumulated as data. Further, the display order of pieces of information of the processing screen of a certain task is decided based on the accumulated data about the processing screens of the tasks that are derived from the same path as the certain task.

In this case, the reason for the path selection is taken into account for the processing screen of a task in an abnormal path, and the display order of pieces of information is decided based on contents that are processed in the task which has entered the abnormal path.

As described above, the display order of pieces of information is decided for the processing screen of each task, the reason why the abnormal path is selected is taken into account for the abnormal path, and the pieces of information that are requested when the user performs decision-making are thereby rearranged in an appropriate display order. Accordingly, the result of rearrangement into an appropriate display order may be indicated to the user.

In this embodiment, a description will be made about a case where the pieces of information that are requested when the user performs decision-making are rearranged at higher levels. However, a case is possible where the requested pieces of information are displayed in positions that are easily recognized by the user, such as a case where the requested pieces of information are displayed even if the processing screen is not scrolled, for example.

Further, while the processing contents of the task in a transition source is taken into account, the display order of the requested pieces of information that are displayed on the processing screen of the task in a transition destination is decided. Accordingly, the pieces of information are displayed in an optimal display order in a phase in which a person in charge of the task in the transition destination logs in a terminal and starts the task.

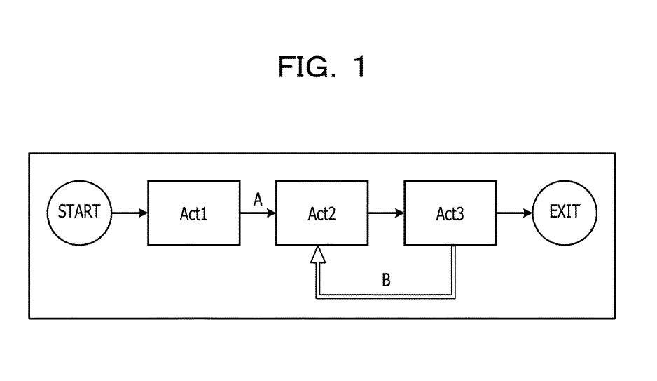

Next, terms used in this embodiment will be defined with reference to FIG. 1. A sequential flow from “start” to “exit (completion)”, which is illustrated in FIG. 1, is defined as a process. Further, each of “Act1”, “Act2”, and “Act3”, which is illustrated in FIG. 1, is defined as a task. Further, each of paths that connect tasks together such as “arrow A” and “arrow B”, which are illustrated in FIG. 1, is defined as a path. The path of “arrow A” illustrated in FIG. 1 is defined as an ordinary path, and the path of “arrow B” illustrated in FIG. 1, in which the task is returned from the task of Act3 to the task of Act2 is defined as an abnormal path.

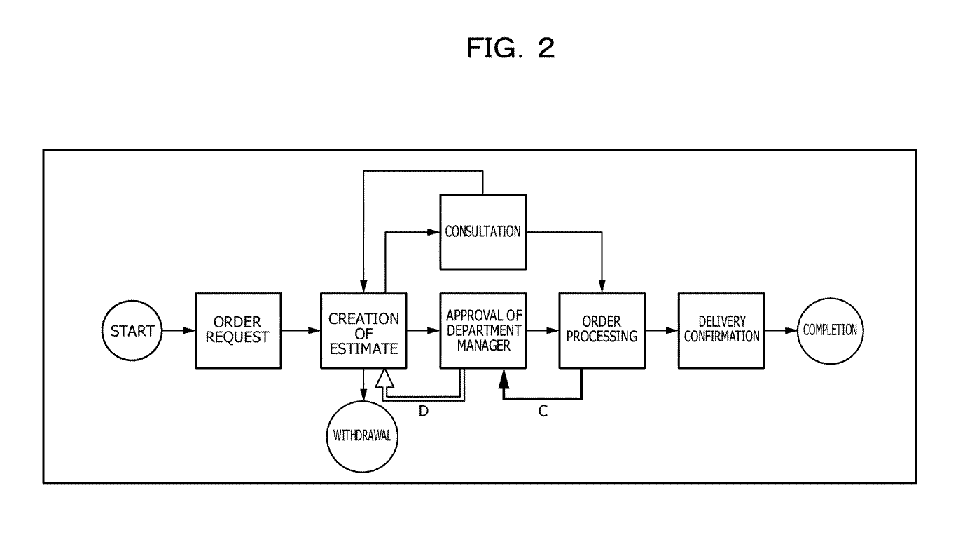

This embodiment will hereinafter be described in detail with reference to drawings. In this embodiment, a description will be made about a workflow that defines a process of article purchase, which is illustrated in FIG. 2, (hereinafter referred to as “article purchase flow”) as one example. A workflow is a processing flow of business procedures that is configured as a pattern, and a process is a processing flow of specific business procedures that are in advance defined as a workflow. Thus, it is possible that plural processes are issued for one workflow.

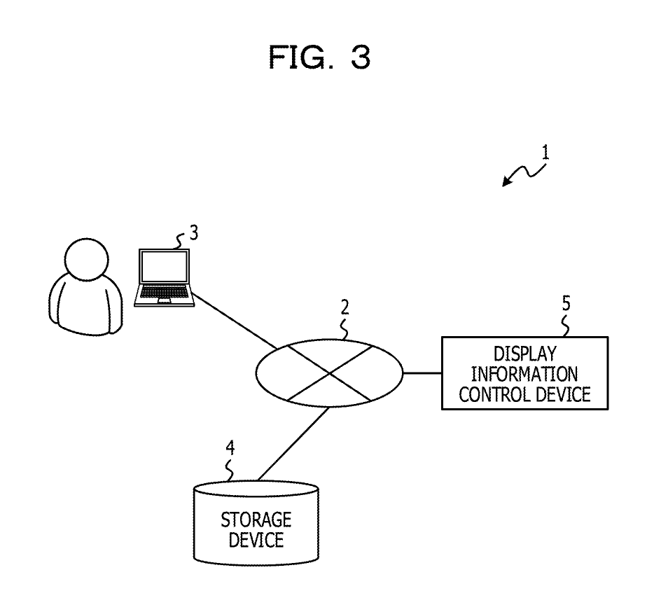

FIG. 3 is a diagram that illustrates one example of a display information control system 1 of this embodiment. As illustrated in FIG. 3, the display information control system 1 has a display information control device 5, a user terminal 3, and a storage device 4.

The display information control device 5 according to this embodiment is connected with the user terminal 3 and the storage device 4 via a network 2 such as the Internet such that mutual communication is feasible.

The number of the user terminal 3 that is included in the display information control system 1 in this embodiment is not limited to the example of FIG. 3. Further, the storage device 4 may be configured to be inside the display information control device 5.

The user terminal 3 is operated by a user who issues a process or a user who executes a processing in a task. Further, the user terminal 3 transmits user input information to the display information control device 5 via the network 2 based on an operation by the user. In this embodiment, it is assumed that the user terminal 3 is used by a person in charge of each task, and the person in charge logs in by his/her log-in ID in using the user terminal 3, starts a specific system, and thereby executes a task of which the person is in charge.

Specifically, when a new process is issued by an operation of the user, the user terminal 3 transmits the user input information that includes a process ID and process name of the new process and issuing information which includes a user name of an issuer to the display information control device 5 via the network 2. Further, it is assumed that the issuing information includes path information that indicates that a transition is performed to the task ID which corresponds to a task which is set as a start of processing of a process.

Here, the path information that indicates that the transition is performed to the task ID which corresponds to the task which is set as a start of processing of a process is expressed by the task ID “0” that indicates “start” and the task ID that corresponds to the task which is set as a start of processing. In this embodiment, in a case where the task ID that corresponds to the task which is set as a start of processing of a process is “21”, the path information is expressed as “0→21”.

It is assumed that the process ID is automatically added as a consecutive number to each issued process. Alternatively, in a case where the process ID is uniquely set, the process ID may be added by another method. Further, it is assumed that a task set as a start of processing is predetermined in a process to be a target.

Further, the user terminal 3 transmits the user input information that includes processing execution information to the display information control device 5 via the network 2 when a processing in a task is executed by an operation of the user. The processing execution information includes the process ID of the process to which the task in which the processing is executed belongs, the task ID for which the processing is performed, a type of action (processing), action contents, an input item ID of an input item that is input, and the user name of an operator.

Here, the type of action is a processing type and may include path selection for selecting a path for a transition of a task, variable update for updating contents of an input item, and so forth. Further, the action content is information that includes the task ID which corresponds to a task in a transition source and the task ID which corresponds to a task in a transition destination in a case where the type of action is the path selection.

Further, the action content is information that includes contents about update of variables in a case where the type of action is the variable update. In a case where the type of action is the path selection, the input item ID included in the processing execution information is set as “-” because no input item is present.

Further, the user terminal 3 displays a screen in which labels of the input items as displayed items are arranged in the priority order based on screen information that is input from the display information control device 5 via the network 2. The screen is one example of the processing screen of the techniques of the present disclosure. The priority is one example of the display order of the techniques of the present disclosure.

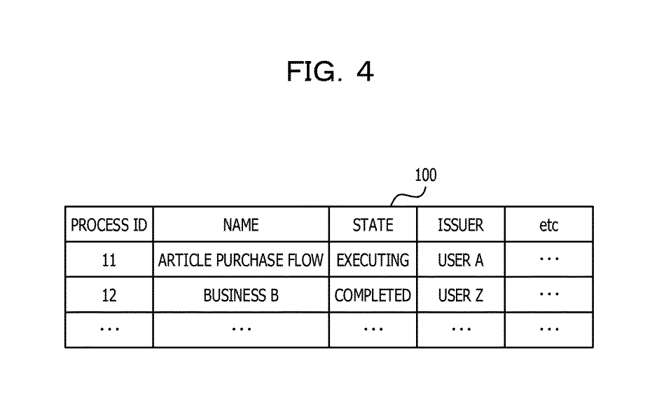

The storage device 4 stores a process information list 100 illustrated in FIG. 4, for example. Here, the process information list 100 has each piece of process information that includes a process ID, a process name, an execution state of the process, and the user name of a user who issues a process. Issuing a process means a start of the process.

A column of “name” of the process information list 100 indicates the process names, a column of “state” indicates the execution states of processes, and a column of “issuer” indicates the names of users who start the processes. Further, each entry (each row) of the process information list 100 corresponds to one piece of the process information.

Further, the process information in the first row of the process information list 100 illustrated in FIG. 4 indicates the process information that corresponds to the article purchase flow according to this embodiment. Specifically, because the process that corresponds to the article purchase flow according to this embodiment is issued but is not completed, the column of “state” of the process information indicates executing. Further, in a case where the corresponding process is completed, the column of “state” of the process information becomes completed.

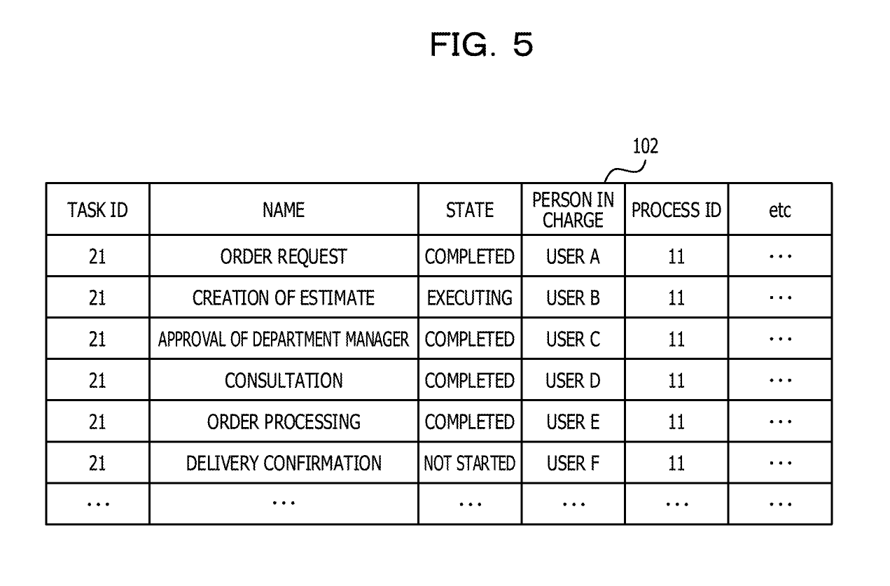

Further, the storage device 4 stores a task information list 102 illustrated in FIG. 5, for example. Here, the task information list 102 has each piece of task information that includes a task ID of a task concerned, a task name, an execution state of a task, the user name of a user who executes a task, and the process ID of a process to which a task concerned belongs.

A column of “name” of the task information list 102 indicates the task names, a column of “state” indicates the execution states of tasks, a column of “person in charge” indicates the user names of users who execute the tasks, and “process ID” indicates the process IDs to which the tasks belong. Further, each entry (each row) of the task information list 102 corresponds to one piece of the task information. Further, the task information from the first row to the sixth row of the task information list 102 illustrated in FIG. 5 indicates the task information that corresponds to the article purchase flow according to this embodiment.

It is assumed that at each time when new process information is added to the process information list 100, each piece of the task information of a task that is in advance defined and corresponds to the added process is automatically added to the task information list 102.

In the phase in which the task information is added to the task information list 102 when the process starts, the “state” column of the entry for the first task of the process is set to “executing”, and the “state” column of the entries for the other tasks is set to “not started”. Further, the “process ID” of the entry for the added task stores the same information as the column of the “process ID” of the entry that corresponds to the added process.

Further, an addition method of an entry is not limited, but any method may be used which involves information included in the task information list 102 illustrated in FIG. 5. In this embodiment, a description will be made about a case where the first task automatically transits to an execution start state when a process is issued. However, the transition to the execution start state may be held until an operation by a person in charge of the first task is performed. In this case, in the phase in which the task information is added to the task information list 102 when the process starts, the “state” column of the entry for the first task of the process is set to “not started”.

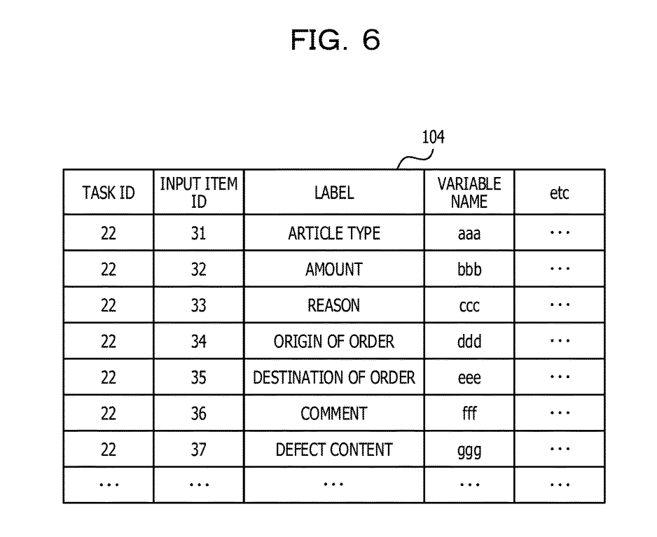

Further, the storage device 4 stores an input screen information list 104 illustrated in FIG. 6, for example. Here, the input screen information list 104 has each piece of input screen information that includes a task ID, an input item ID, a label name, and a variable name.

Further, a column of “task ID” of the input screen information list 104 indicates the task ID to which the input item which corresponds to an input item ID of a column of “input item ID” belongs. Further, a column of “label” indicates the label name that is indicated in a screen of the input item which corresponds to an input item ID of the column of the “input item ID”. Further, the “variable name” indicates the variable name that corresponds to an input item which corresponds to an input item ID of the column of the “input item ID”. Further, the input screen information from the first row to the seventh row of the input screen information list 104 illustrated in FIG. 6 indicates each piece of the input screen information that corresponds to a task of “creation of estimate” of the article purchase flow according to this embodiment.

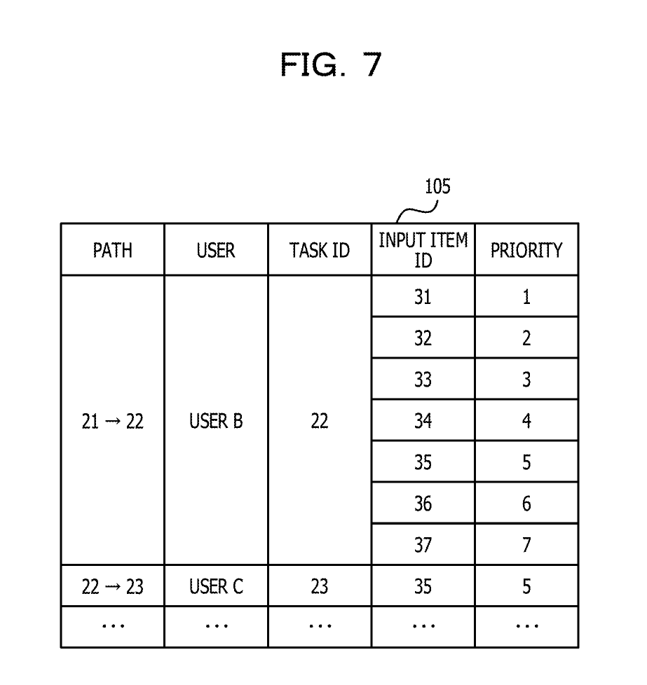

Further, the storage device 4 stores a display priority information list 105 illustrated in FIG. 7, for example. Here, the display priority information list 105 has each piece of display priority information that sets a degree of display priority of each input item with respect to each combination of path and user.

Further, a column of “path” of the display priority information list 105 indicates information in which information of a path is indicated by a task ID and is indicated by the relationship of “a task ID in a transition source a task ID in a transition destination”. Further, a column of “user” indicates the user name of a person in charge of the task in the transition destination. Further, a column of “task ID” indicates the task ID of the task in the transition destination. Further, a column of “input item ID” indicates the input item ID that corresponds to each input item in the task in the transition destination. Further, “priority” indicates the display priority of the input item that corresponds to each input item ID. In this embodiment, the priority with a smaller number value represents higher priority.

For example, the display priority information in the first row of the display priority information list 105 illustrated in FIG. 7 indicates the display priority order of each of the input items of the task of “creation of estimate” with respect to the combination of the path of “order request creation of estimate” and the user “user B” in the article purchase flow illustrated in FIG. 2.

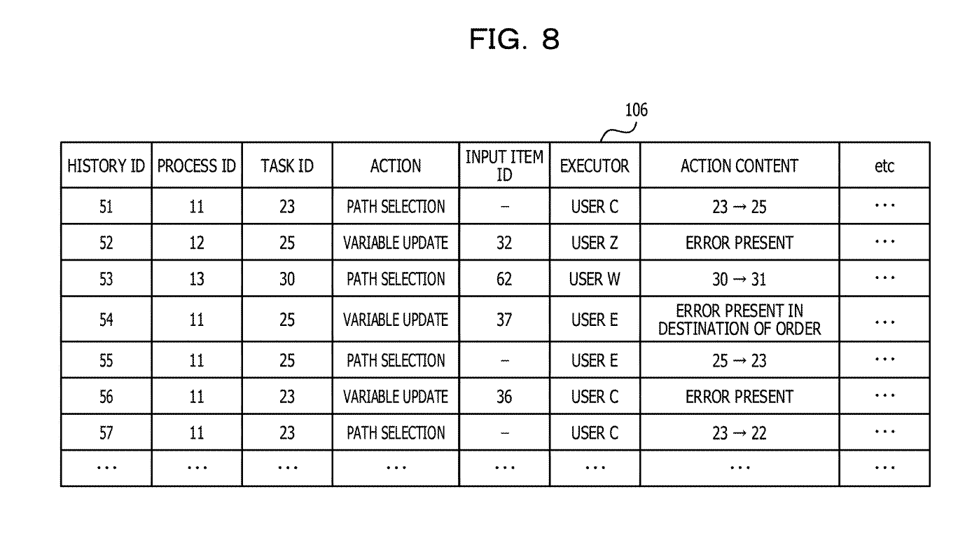

Further, the storage device 4 stores a process execution history list 106 illustrated in FIG. 8, for example. Here, the process execution history list 106 has each piece of process execution information that includes a history ID, a process ID, a task ID, a type of action, an input item ID, the user name of an executor, an action content.

The process execution information is examples of a task processing history and a task processing content of the techniques of the present disclosure. Further, the process execution history list 106 is examples of the task processing history, task processing information, and processing history information of the techniques of the present disclosure. Further, it is assumed that the history ID is added as a consecutive number in the order of processing of tasks.

Further, a column of “action” of the process execution history list 106 indicates the type of action in execution of a task included in a process concerned, and a column of “action content” indicates a content performed in the action. In a case where no target input item is present in the column of “input item ID”, a character of “-” is stored in the column.

Further, for example, the pieces of process execution information that correspond to “51” and “54” to “57” in the column of “history ID” of the process execution history list 106 illustrated in FIG. 8 are the process execution information that corresponds to the article purchase flow illustrated in FIG. 2. Thus, each piece of the process execution information is referred to, and what kind of processing is performed in what kind of transition between tasks may be identified in the process in the article purchase flow.

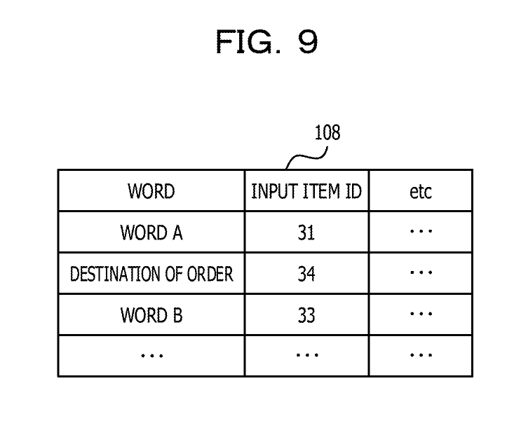

Further, the storage device 4 stores a word correspondence list 108 illustrated in FIG. 9, for example. Here, the word correspondence list 108 has each piece of word correspondence information that includes a word and the input item ID which corresponds to the word. Further, the word is one example of a term of the techniques of the present disclosure. Further, the word correspondence information is one example of term information of the techniques of the present disclosure.

Further, a column of “word” of the word correspondence list 108 indicates words that are in advance defined, and a column of “input item ID” indicates the input item IDs of the input item that correspond to the words which are in advance defined. Here, the relationship between the word that is in advance defined and the corresponding input item indicates that the input item is associated with the word. Thus, in a case where the word that is in advance defined is included in an execution result of a task, it may be considered that the input item that corresponds to the word influences the execution result of the task.

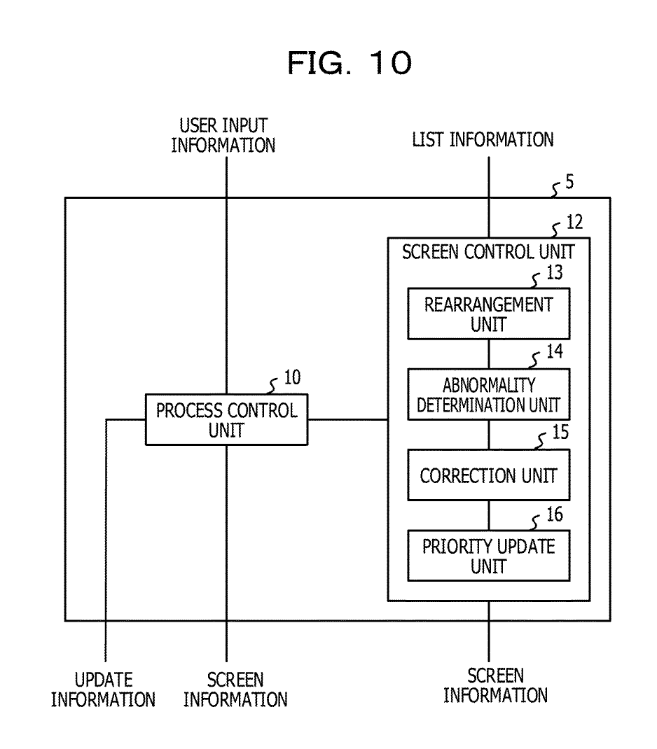

Next, the display information control device 5 according to this embodiment will be described. FIG. 10 illustrates a functional block diagram of the display information control device 5 according to this embodiment. As illustrated in FIG. 10, the display information control device 5 has a process control unit 10 and a screen control unit 12.

The process control unit 10 transmits update information to the storage device 4 via the network 2 based on the user input information that is input from the user terminal 3 via the network 2 and updates each content of the lists stored in the storage device 4. Information transmitted from the process control unit 10 to the storage device 4 via the network 2 in a case of update will be generically referred to as update information.

Specifically, when the process control unit 10 receives the user input information that includes the issuing information, the process control unit 10 updates the process information list 100 stored in the storage device 4 via the network 2 based on the issuing information. Here, the process control unit 10 stores information of the process name of the issuing information in the column of “name” of the process information list 100 and stores information that sets the column of “state” as executing.

Further, when the process control unit 10 receives the user input information that includes the processing execution information, the process control unit 10 updates the process execution history list 106 stored in the storage device 4 via the network 2 based on the processing execution information.

Here, the process control unit 10 stores information of the process ID of the processing execution information in the column of “process ID” of the process execution history list 106 and stores information of the task ID of the processing execution information in the column of “task ID”.

Here, the process control unit 10 stores information of the type of action in the column of “action” of the process execution history list 106 and stores information of the input item ID of a processing target in the column of “input item ID”. Further, the process control unit 10 stores information of the user name of an operator in a column of “executor” of the process execution history list 106 and stores information of an action content in the column of “action content”.

Further, when the process control unit 10 receives the user input information that includes the issuing information or the processing execution information, the process control unit 10 outputs the user input information that includes the issuing information or the processing execution information to the screen control unit 12.

Further, the process control unit 10 configures the screen such that the label names of the respective input items are displayed in the arrangement in the priority orders of the input items based on screen configuration information (details will be described later) that is input from the screen control unit 12 and transmits information of the screen as the screen information to the user terminal 3 via the network 2.

When the screen control unit 12 receives the user input information from the process control unit 10, the screen control unit 12 creates the screen configuration information and outputs that to the process control unit 10. Further, the screen control unit 12 has a rearrangement unit 13, an abnormality determination unit 14, a correction unit 15, and a priority update unit 16. Each piece of information that is input in a case where the screen control unit 12 acquires various lists stored in the storage device 4 via the network 2 will be generically referred to list information.

First, a case will be described where the rearrangement unit 13 receives the user input information that includes the issuing information from the process control unit 10.

When the rearrangement unit 13 receives the user input information that includes the issuing information, the rearrangement unit 13 identifies the user in charge of the task set as the start of processing of the process based on the path information and the process ID that are included in the issuing information and the task information list 102. It is assumed that the rearrangement unit 13 acquires the task information list 102 from the storage device 4 via the network 2. Further, it is assumed that the task set as the start of processing of the process is a display target task in an initial state.

Specifically, the rearrangement unit 13 acquires each piece of the task information in which the column of “process ID” of the task information included in the task information list 102 matches the process ID included in the issuing information. Further, the rearrangement unit 13 acquires the task information, in which the column of “task ID” matches the task ID that corresponds to the display target task of the path information included in the issuing information, among the acquired pieces of task information, as the task information to be a target.

Further, the rearrangement unit 13 identifies the information of the column of “person in charge” of the acquired task information to be a target as the user in charge of the task set as the start of processing of the process.

Further, the rearrangement unit 13 acquires the display priority information that corresponds to the combination of the path information included in the acquired issuing information and the identified user from the display priority information list 105. It is assumed that the rearrangement unit 13 acquires the display priority information list 105 from the storage device 4 via the network 2.

Further, the rearrangement unit 13 acquires each combination of the input item ID and the priority order of the input item ID based on the acquired display priority information. The rearrangement unit 13 acquires the input item ID from the information of the column of “input item ID” of the display priority information and acquires the priority order of the input item ID from the information of a column of “priority” in the same row.

Further, the rearrangement unit 13 creates the screen configuration information based on the acquired task ID of the display target task, each of the acquired combinations of the input item IDs and the priority orders of the input item IDs, and the input screen information list 104. It is assumed that the rearrangement unit 13 acquires the input screen information list 104 from the storage device 4 via the network 2.

Specifically, the rearrangement unit 13 acquires the pieces of input screen information, in which the information of the column of “task ID” matches the task ID of the acquired display target task, among the pieces of input screen information included in the input screen information list 104.

Further, with respect to each of the acquired combinations of the input item IDs and the priority orders of the input item IDs, the rearrangement unit 13 identifies the corresponding input screen information, in which the information of the column of “input ID” of the acquired input screen information matches the input item ID of the combination, in the priority order.

Further, with respect to each of the acquired combinations of the input item IDs and the priority orders of the input item IDs, the rearrangement unit 13 acquires the combination of the label name and the variable name from the column of “label” and the column of “variable name” of the corresponding input screen information in the priority order.

Further, the rearrangement unit 13 outputs the information in which the combination of the label name and the variable name, which is acquired with respect to each of the acquired combinations of the input item IDs and the priority orders of the input item IDs, is arranged in the priority order to the process control unit 10 as the screen configuration information.

Next, a case will be described where the rearrangement unit 13 receives the user input information that includes the processing execution information from the process control unit 10. It is assumed that the rearrangement unit 13 executes subsequent processings in a case where the type of action of the processing execution information is “path selection” but does not perform subsequent processings in a case of “variable update”.

When rearrangement unit 13 receives the user input information that includes the processing execution information, the rearrangement unit 13 identifies the user in charge of the task in the transition destination based on the information of the action content and the process ID that are included in the processing execution information and the task information list 102. It is assumed that the rearrangement unit 13 acquires the task information list 102 from the storage device 4 via the network 2.

Specifically, the rearrangement unit 13 acquires each piece of the task information in which the column of “process ID” of the task information included in the task information list 102 matches the process ID included in the processing execution information. Further, the rearrangement unit 13 acquires the task information, in which the column of “task ID” matches the task ID that corresponds to the task in the transition destination which is included in the processing execution information, among the acquired pieces of task information, as the task information to be a target.

Further, the rearrangement unit 13 identifies the information of the column of “person in charge” of the acquired task information to be a target as the user in charge of the task in the transition destination.

Further, the rearrangement unit 13 acquires the display priority information that corresponds to the combination of the path information included in the information of the action content included in the acquired processing execution information and the identified user from the display priority information list 105. It is assumed that the rearrangement unit 13 acquires the display priority information list 105 from the storage device 4 via the network 2.

Further, the rearrangement unit 13 acquires each combination of the input item ID and the priority order of the input item ID based on the acquired display priority information. The rearrangement unit 13 acquires the input item ID from the information of the column of “input item ID” of the display priority information and acquires the priority order of the input item ID from the information of the column of “priority” in the same row.

Further, the rearrangement unit 13 acquires the pieces of input screen information that are arranged in the priority order based on the acquired task ID of the task in the transition destination, the acquired combinations of the input item IDs and the priority orders of the input item IDs, and the input screen information list 104. It is assumed that the rearrangement unit 13 acquires the input screen information list 104 from the storage device 4 via the network 2.

Specifically, the rearrangement unit 13 acquires the pieces of input screen information, in which the information of the column of “task ID” matches the acquired task ID of the task in the transition destination, among the pieces of input screen information included in the input screen information list 104.

Further, with respect to each of the acquired combinations of the input item IDs and the priority orders of the input item IDs, the rearrangement unit 13 identifies the corresponding input screen information, in which the information of the column of “input ID” of the acquired input screen information matches the input item ID of the combination, in the priority order. It is assumed that the rearrangement unit 13 retains each piece of the input screen information in a form in which the pieces of input screen information are arranged in the identified order. Thus, the piece of input screen information has the priority order that is the order in the arrangement.

Further, the rearrangement unit 13 outputs each piece of the path information included in the information of the action content included in the processing execution information and each piece of the input screen information that is arranged in the priority order to the abnormality determination unit 14. Further, the rearrangement unit 13 outputs each piece of the input screen information that is arranged in the priority order to the correction unit 15.

The abnormality determination unit 14 determines whether or not the task in the transition destination arrives via an abnormal path based on the path information input from the rearrangement unit 13 and the process execution history list 106 stored in the storage device 4. It is assumed that the abnormality determination unit 14 acquires the process execution history list 106 from the storage device 4 via the network 2.

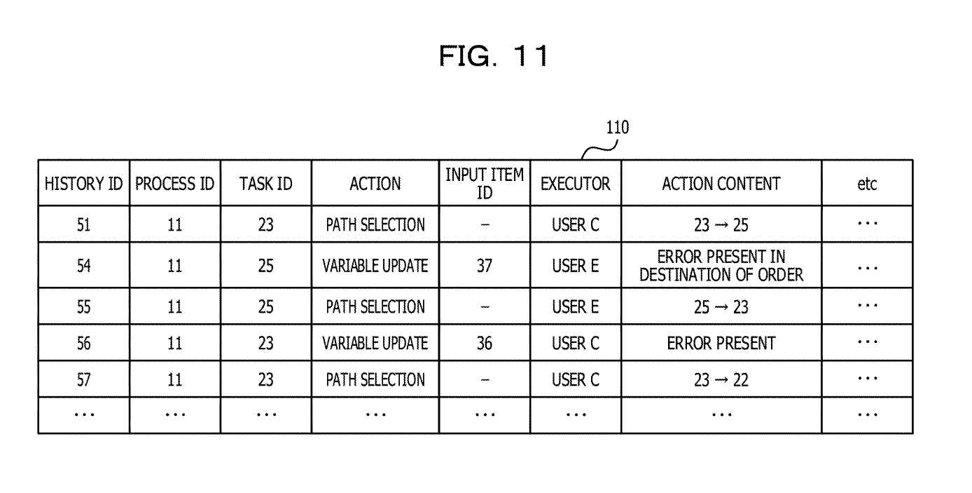

Specifically, the abnormality determination unit 14 acquires each piece of the process execution information in which the information of the process ID of the processing execution information which is received from the process control unit 10 matches the information of the column of “process ID” of the process execution information included in the process execution history list 106. Further, the abnormality determination unit 14 generates a subject process execution history list 110 illustrated in FIG. 11 based on each piece of the acquired process execution information.

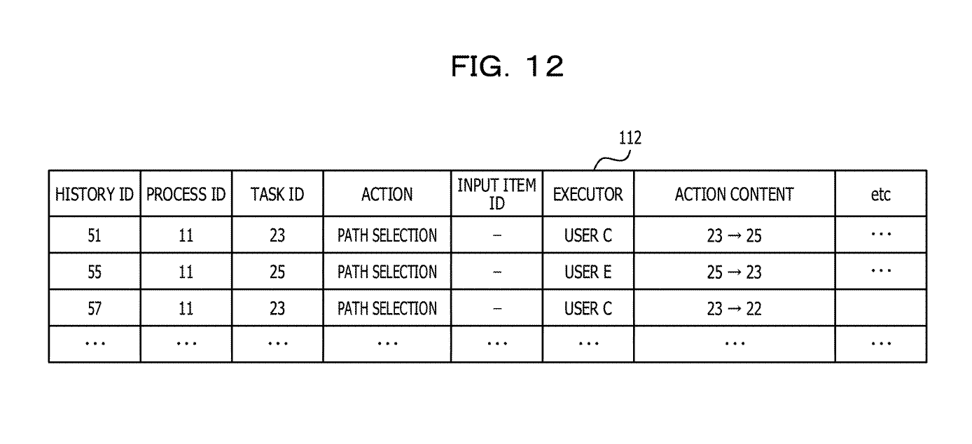

Further, the abnormality determination unit 14 acquires each piece of the process execution information, in which the information of the column of “action” is “path selection”, from the generated subject process execution history list 110 and generates a path selection execution history list 112 illustrated in FIG. 12.

Further, the abnormality determination unit 14 arranges each piece of the process execution information of the generated path selection execution history list 112 in the ascending order of the information of the column of “history ID” and acquires information, in which each piece of the information of the column of “task ID” of the process execution information is extracted while the order is maintained, as task transition history information. For example, FIG. 12 illustrates an example of “23→25→23”.

The task ID included in the task transition history information is acquired from each piece of the process execution information included in the path selection execution history list 112. Thus, it is assumed that the task IDs included in the task transition history information are associated with the respective pieces of process execution information included in the path selection execution history list 112.

Further, the abnormality determination unit 14 determines whether or not the acquired task transition history information includes the task ID that matches the task ID of the task in the transition destination included in the path information which is acquired from the processing execution information.

In a case where the abnormality determination unit 14 determined that the matched task ID is included, the abnormality determination unit 14 determines that the task is in an abnormal path because returning of a task has occurred. Then, the abnormality determination unit 14 outputs each piece of the process execution information that is arranged in the ascending order of the information of the column of “history ID” and the acquired task transition history information to the correction unit 15.

In a case where the acquired task transition history information does not include a matched task ID, the abnormality determination unit 14 determines that the task is not in an abnormal path.

Further, in a case where the abnormality determination unit 14 determines that the task is not in an abnormal path, the abnormality determination unit 14 creates the screen configuration information based on each piece of the input screen information that is arranged in the priority order acquired from the rearrangement unit 13 and outputs the screen configuration information to the process control unit 10.

Specifically, the abnormality determination unit 14 acquires the combination of the label name and the variable name from the column of “label” and the column of “variable name” of the input screen information with respect to each piece of the acquired input screen information.

Further, the abnormality determination unit 14 outputs information, in which the acquired combination of the label name and the variable name is arranged in the priority order in the input screen information that corresponds to each of the combinations, to the process control unit 10 as the screen configuration information.

The correction unit 15 determines whether or not the previous task to the task in the transition destination is in an abnormal path based on the task transition history information that is input from the abnormality determination unit 14.

Specifically, the correction unit 15 makes a determination based on whether or not the task ID in the end of the task transition history information is present in front of the task ID in the task transition history information. Here, in a case where the correction unit 15 determines that the previous task is in the abnormal path, the correction unit 15 performs a determination processing whether or not the further previous task ID is similarly in the abnormal path.

Until a determination is made that the task is not in the abnormal path, the correction unit 15 sequentially performs a determination processing whether or not the task is in the abnormal path with respect to each of the task ID in the end of the task transition history information and the next front task ID.

On the other hand, in a case where the correction unit 15 determines that the previous task is not in the abnormal path, the correction unit 15 sets the last task that is determined as being in the abnormal path to the present task in the transition destination as processing target tasks in the opposite order from the order of the determinations and executes the following processing. In a case where a determination is made that the task that corresponds to the task ID in the end of the task transition history information is not in the abnormal path, the correction unit 15 executes the following processing only for the task in the transition destination.

The correction unit 15 acquires the process execution information that corresponds to the previous task to the processing target task in the task transition history information from each piece of the process execution information of the subject process execution history list 110, as previous process execution information.

Further, the correction unit 15 determines whether or not there is an item that is input in the previous task to the processing target task based on the acquired previous process execution information and the process execution history list 106.

Specifically, the correction unit 15 acquires the process execution information, which is the immediately previous process execution information which matches the “task ID” of the acquired previous process execution information and in which the information of the column of “action” is “variable update”, from the subject process execution history list 110. In a case where the correction unit 15 acquires the immediately previous process execution information that matches the “task ID” of the previous process execution information, the correction unit 15 determines that there is an item that is input in the previous task.

Further, in a case where a determination is made that there is an item that is input in the previous task, the correction unit 15 corrects the priority of each piece of the input screen information that is arranged in the priority order which is input from the rearrangement unit 13 or corrected in the previous time.

Specifically, the correction unit 15 acquires the information of the column of “input item ID” of the immediately previous process execution information that matches the “task ID” of the acquired previous process execution information, as the input item ID that is input in the previous task.

Further, the correction unit 15 corrects the arrangement order of the pieces of input screen information such that the pieces of information of the column of “input item ID” of the input screen information which are arranged in the acquired or previously corrected priority order are moved so that the arrangement order of the pieces of input screen information that matches the acquired input item IDs comes to the top.

In addition, the correction unit 15 determines whether or not the information of the column of “action content” of the immediately previous process execution information, which corresponds to the “task ID” of the acquired previous process execution information, corresponds to the word correspondence information included in the word correspondence list 108. Here, in a case where the “action content” of the immediately previous process execution information that matches the “task ID” of the previous process execution information includes the information of the column of “word” of the word correspondence information, the correction unit 15 determines that the acquired process execution information corresponds to the word correspondence information.

Here, a description will be made about a case where the immediately previous process execution information, which matches the “task ID” of the acquired previous process execution information, corresponds to the word correspondence information. The correction unit 15 identifies the input screen information in which the information of the column of “input item ID” of the word correspondence information that corresponds to the information of the column of “action content” matches the information of the column of “input item ID” of the input screen information that is rearranged in the corrected priority order. This processing is omitted in a case where the matched input screen information is not present. Further, this processing may be omitted in a case where the arrangement order of the matched input screen information comes to the first position.

Then, the correction unit 15 corrects the arrangement order of the input screen information such that the arrangement order of the identified input screen information is moved to the position under the item moved to the top. In a case where plural pieces of identified input screen information are present, the correction unit 15 may correct the arrangement order of the input screen information such that the pieces of input screen information are in an arbitrary order moved to the position under the item moved to the top.

The correction unit 15 repeats an above correction processing until the processing for the task in the transition destination is finished.

Then, the correction unit 15 creates the screen configuration information based on the pieces of input screen information that are corrected and rearranged and outputs the screen configuration information to the process control unit 10.

Specifically, the correction unit 15 acquires the combination of the label name and the variable name from the column of “label” and the column of “variable name” of the input screen information with respect to each piece of the input screen information, which is corrected and rearranged, in a corrected arrangement order (priority order).

Further, the correction unit 15 outputs information in which the combination of the label name and the variable name, which is acquired in the priority order, is arranged in the priority order to the process control unit 10 as the screen configuration information.

Here, a description will be made about the article purchase flow of FIG. 2 as one example of the correction processing. In the example of FIG. 2, the path of “start”→“order request”→“creation of estimate”→“approval of department manager”→“order processing” goes through an ordinary path. On the other hand, the path that has the task “order processing” as a start point and goes through “approval of department manager (abnormal path C)”→“creation of estimate (abnormal path D)” is in the abnormal path.

In this example, it is assumed that “Error present in destination of order” is input in the input item “defect content” in the task “order processing”. In addition, it is assumed that a transition is performed from the task “order processing” to the task “approval of department manager” by the action “path selection” and “Correct defect” is input in the input item “comment” in the task “approval of department manager”.

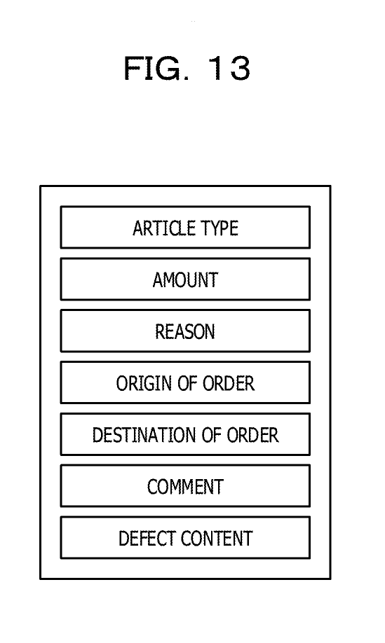

In this case, it is assumed that the priority orders of the input items of the combination of “path B” as the path that reaches the task “creation of estimate” and “User B” who is the person in charge of the “creation of estimate” are the arrangement order illustrated in FIG. 13. In this case, replacement is first performed such that the arrangement order of the input item of “defect content” that is input in the “order processing” as the start point of the abnormal path comes to the top. Next, rearrangement is performed such that the content “Error present in destination of order” that is input in the input item “defect content” corresponds to the word correspondence information in the second row of the word correspondence list 108 and the input item “destination of order” that corresponds to the input item ID comes to the second position.

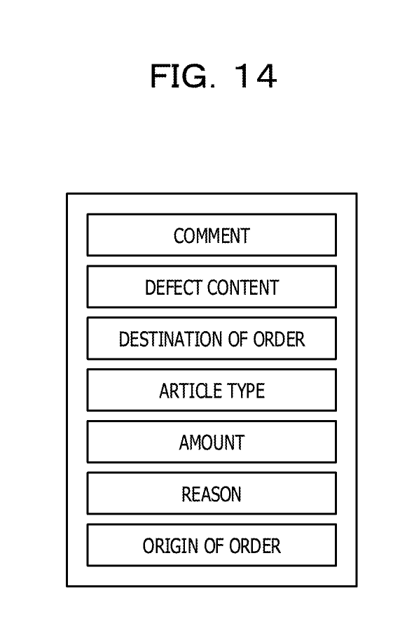

Next, replacement is performed such that the arrangement order of the input item “comment”, which is input in the task “approval of department manager” to which the transition is performed from the task “order processing”, that is, the task “approval of department manager” in the abnormal path, comes to the top. As a result, the orders of the input items in the task “creation of estimate” that goes through the abnormal path become the orders illustrated in FIG. 14. It is assumed that there is no word correspondence information that corresponds to the content input in the task “approval of department manager” in the abnormal path.

Meanwhile, in a case where the correction unit 15 does not acquire the immediately previous process execution information that matches the “task ID” of the previous process execution information, the correction unit 15 creates the screen configuration information based on each piece of the input screen information that is arranged in the priority order acquired from the rearrangement unit 13 and outputs the screen configuration information to the process control unit 10.

Specifically, the correction unit 15 acquires the combination of the label name and the variable name from the column of “label” and the column of “variable name” of the input screen information with respect to each piece of the acquired input screen information, in the priority order.

Further, the correction unit 15 outputs information in which the combination of the label name and the variable name, which is acquired in the priority order, is arranged in the priority order to the process control unit 10 as the screen configuration information.

When the priority update unit 16 receives the processing execution information from the process control unit 10, the priority update unit 16 updates the display priority information based on the process execution history list 106, the task information list 102, and the display priority information list 105. The priority update unit 16 performs the following processing in a case where the priority update unit 16 receives the processing execution information in which the type of action is “variable update” from the process control unit 10.

Further, it is assumed that the priority update unit 16 acquires the process execution history list 106, the task information list 102, and the display priority information list 105 from the storage device 4 via the network 2.

Specifically, the priority update unit 16 acquires the information of the column of “person in charge” of the task information, in which the column of “task ID” of the task information included in the task information list 102 matches the information of the task ID of the processing execution information, as the information of the user.

Further, the priority update unit 16 acquires the process execution information, in which the “process ID” of the process execution information included in the process execution history list 106 matches the process ID of the processing execution information.

Further, the priority update unit 16 identifies the process execution information, in which the column of “action” is “path selection” and the value of the column of “history ID” is the largest, among the acquired pieces of process execution information. Further, the priority update unit 16 acquires the path information of the column of “action content” of the identified process execution information.

Further, the priority update unit 16 acquires the display priority information that corresponds to the combination of the acquired path information and information of the user from the display priority information list 105.

Further, the priority update unit 16 creates temporary display priority information, in which the priority order of the input item ID in the acquired display priority information that corresponds to the input item ID which is input and included in the acquired processing execution information, is set as 1 and the orders of the other input item IDs are set in accordance with the priority order.

Further, with respect to each of the input item IDs of the acquired temporary display priority information and the acquired display priority information, the priority update unit 16 calculates the value obtained by dividing the sum of the values of the priority order of the temporary display priority information and the priority order of the display priority order by two, and sets the obtained value as the priority order of each of the input item IDs.

Then, the priority update unit 16 updates the display priority information such that the priority order of each of the calculated input item IDs is reflected in the corresponding display priority information included in the display priority information list 105. The calculated priority order of each of the input item IDs serves as priority update information.

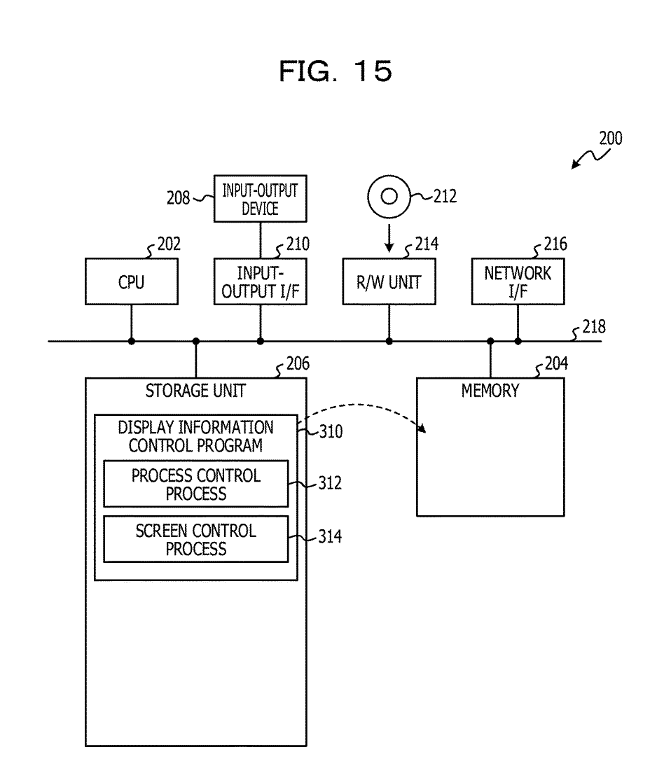

The display information control device 5 may be realized by a computer 200, which is illustrated in FIG. 15, for example. The computer 200 includes a CPU 202, a memory 204 as a temporary storage area, and a non-volatile storage device 206. Further, the computer 200 includes an input-output interface (I/F) 210 with which an input-output device 208 is connected. Further, the computer 200 includes a read/write (R/W) unit 214 that controls reading of data from and writing of data in a recording medium 212, and a network I/F 216 that is connected with the network 2 such as the Internet. The CPU 202, the memory 204, the storage device 206, the input-output I/F 210, the R/W unit 214, and the network I/F 216 are connected with each other via a bus 218.

The storage device 206 may be realized by a hard disk drive (HDD), a solid state drive (SSD), a flash memory, or the like. The storage device 206 as a storage medium stores a display information control program 310 that causes the computer 200 to function as the display information control device 5.

The CPU 202 reads out the display information control program 310 from the storage device 206 and expands that in the memory 204. Further, the CPU 202 sequentially executes processes contained in the display information control program 310.

The display information control program 310 has a process control process 312 and a screen control process 314.

The CPU 202 executes the process control process 312 and thereby operates as the process control unit 10 illustrated in FIG. 10. Further, the CPU 202 executes the screen control process 314 and thereby operates as the screen control unit 12 illustrated in FIG. 10.

Accordingly, the computer 200 that executes the display information control program 310 functions as the display information control device 5.

Further, the display information control device 5 may be realized by a semiconductor integrated circuit, more particularly, an application specific integrated circuit (ASIC) or the like, for example.

Next, a description will be made about work of the display information control device 5 according to this embodiment. When the display information control device 5 receives the user input information that includes the issuing information from the user terminal 3 via the network 2, the process control unit 10 updates the process information list 100 stored in the storage device 4 via the network 2 based on the issuing information.

Further, when the display information control device 5 receives the user input information that includes the processing execution information from the user terminal 3, the process control unit 10 updates the process execution history list 106 stored in the storage device 4 via the network 2 based on the processing execution information.

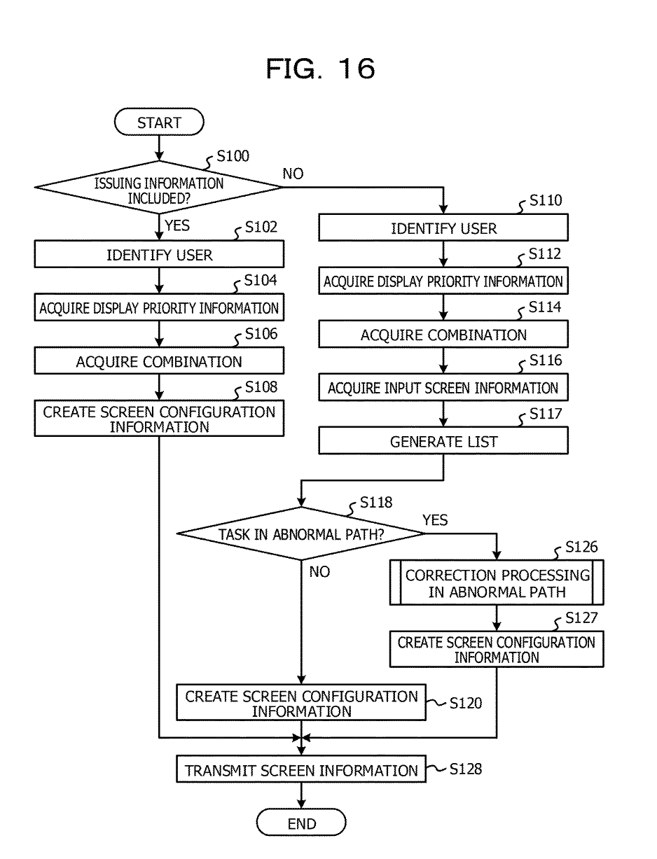

Further, when the display information control device 5 receives the user input information that is transmitted from the user terminal 3, the display information control device 5 executes a display information control processing, which is illustrated in FIG. 16. The display information control processing will be described in detail below.

FIG. 16 is a flowchart that illustrates one example of the display information control processing. In the flowchart of the display information control processing that is illustrated in FIG. 16, in step S100, the rearrangement unit 13 first determines whether or not the received user input information includes the issuing information. In a case where the rearrangement unit 13 determines that the user input information includes the issuing information, the display information control processing moves to step S102.

Meanwhile, in a case where the rearrangement unit 13 determines that the user input information includes the processing execution information in which the type of action is “path selection”, the display information control processing moves to step S110. The display information control processing finishes in a case where the type of action of the processing execution information is “variable update”.

In step S102, the rearrangement unit 13 next identifies the user in charge of the task set as the start of processing of the process based on the received issuing information and the task information list 102.

In step S104, the rearrangement unit 13 next acquires the display priority information that corresponds to the combination of the path information included in the received issuing information and the user who is identified in step S102 from the display priority information list 105.

In step S106, the rearrangement unit 13 next acquires each combination of the input item ID and the priority order of the input item ID based on the display priority information that is acquired in step S104.

In step S108, the rearrangement unit 13 next creates the screen configuration information based on the path information included in the received issuing information, each of the combinations that is acquired in step S106, and the input screen information list 104. That is, in this step, the screen configuration information of the processing screen of the first task of the started process is generated.

In step S110, the rearrangement unit 13 identifies the user in charge of the task in the transition destination based on the information of the action content and the process ID that are included in the received processing execution information and the task information list 102.

In step S112, the rearrangement unit 13 next acquires the display priority information, which corresponds to the combination of the path information included in the information of the action content included in the received processing execution information and the user who is identified in step S110, from the display priority information list 105.

In step S114, the rearrangement unit 13 next acquires each combination of the input item ID and the priority order of the input item ID based on the display priority information that is acquired in step S112.

In step S116, the rearrangement unit 13 next acquires the corresponding input screen information with respect to each of the combinations that is acquired in step S114 and acquires the pieces of input screen information while arranging the pieces of acquired input screen information in the priority orders of the corresponding input item IDs. Based on the received processing execution information, each of the combinations that is acquired in step S114, and the input screen information list 104, the rearrangement unit 13 acquires the input screen information that corresponds to each of the combinations.

In step S117, the abnormality determination unit 14 next generates the subject process execution history list 110 based on the received processing execution information and the process execution history list 106. Further, the abnormality determination unit 14 generates the path selection execution history list 112 based on the generated subject process execution history list 110.

In step S118, the abnormality determination unit 14 next determines whether or not the task in the transition destination arrives via the abnormal path based on the path information of the received processing execution information and the path selection execution history list 112 that is generated in step S117. In a case where the abnormality determination unit 14 determines that the task arrives via the abnormal path, the display information control processing moves to step S126. On the other hand, in a case where the abnormality determination unit 14 determines that the task does not arrive via the abnormal path, the display information control processing moves to step S120. In step S118, the abnormality determination unit 14 acquires the task transition history information and each piece of the process execution information that is associated with the task transition history information based on the path selection execution history list 112 that is generated in step S117.

In step S120, the abnormality determination unit 14 next creates the screen configuration information based on each piece of the input screen information that is acquired in step S116. That is, in this step, the screen configuration information of the processing screen of the task in the transition destination in a case of a transition through the ordinary path is generated.

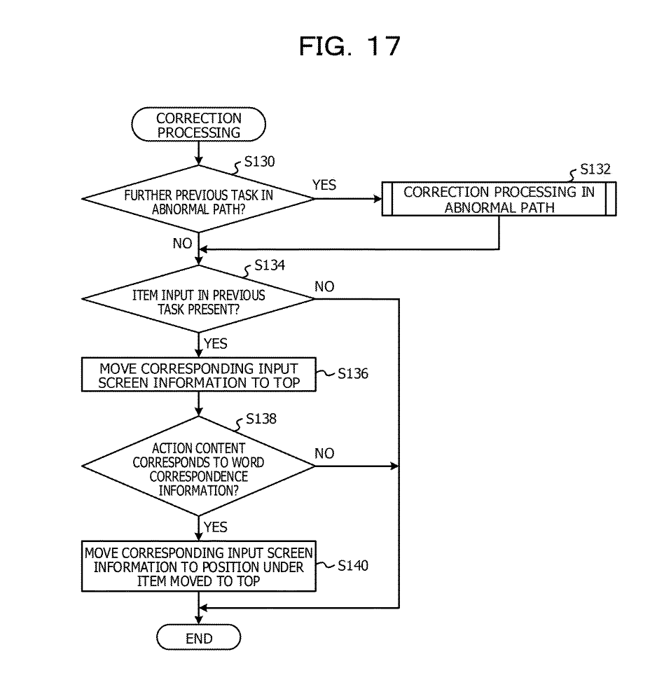

Meanwhile, in step S126, the correction unit 15 corrects the arrangement order of the pieces of input screen information that are acquired in step S116. A correction processing in step S126 will be described in detail below with reference to FIG. 17.

In step S130 in the correction processing of FIG. 17, the correction unit 15 determines whether or not the previous task to the task in the transition destination is in the abnormal path based on the task transition history information that is acquired in step S118. In a case where the correction unit 15 determines that the previous task is in the abnormal path, the correction processing moves to step S132. On the other hand, in a case where the correction unit 15 determines that the previous task is not in the abnormal path, the correction processing moves to step S134.

In step S132, the correction unit 15 changes the processing target task to the task that corresponds to the task ID in the end of the task transition history information or to the previous task to the present processing target task and performs the correction processing illustrated in FIG. 17. In a case where the correction unit 15 changes the processing target tasks in step S132 and finishes the correction processing illustrated in FIG. 17, the processing target task is changed to the task that is set as the processing target before the present processing target, and the correction processing moves to step S134.

In step S134, the correction unit 15 next determines whether or not there is an item that is input in the previous task based on the process execution information and the task transition history information that are acquired in step S118 and the subject process execution history list 110. In a case where the correction unit 15 determines that there is an item that is input, the correction processing moves to step S136. On the other hand, in a case where the correction unit 15 determines that there is not an item that is input, the correction processing finishes.

In step S136, the correction unit 15 next moves the order of the acquired input screen information, which corresponds to the process execution information, to the top based on the process execution information that corresponds to the item which is input and is acquired in step S134. It is assumed that the input screen information is each piece of the input screen information that is acquired in step S118 or acquired in the correction processing in the previous time.

In step S138, the correction unit 15 next determines whether or not there is the word correspondence information that is included in the word correspondence list 108 and corresponds to the action content of the process execution information which corresponds to the item that is input and is acquired in step S134. In a case where the correction unit 15 determines that there is the word correspondence information, the correction processing moves to step S140. On the other hand, in a case where the correction unit 15 determines that there is not the word correspondence information, the correction processing finishes.

In step S140, the correction unit 15 next moves the pieces of input screen information that corresponds to the corresponding word correspondence information which is acquired in step S138 and that are acquired and rearranged in step S136 to the position under the item moved to the top, and the correction processing finishes.

In step S127 in the display information control processing of FIG. 16, the correction unit 15 creates the screen configuration information based on each piece of the input screen information that is acquired in step S126. That is, in this step, the screen configuration information of the processing screen of the task in the transition destination in a case of a transition through the abnormal path is generated.

In step S128, the process control unit 10 next creates the screen information based on the screen configuration information that is acquired in step S108, step S120, or step S127, transmits the screen information to the user terminal 3 via the network 2, and finishes the display information control processing.

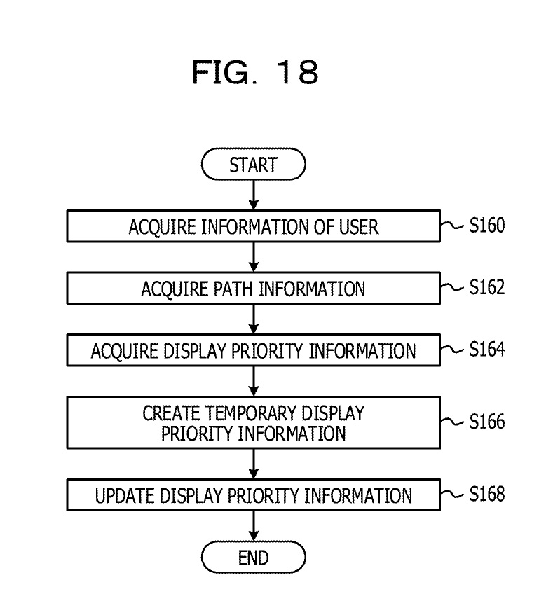

Further, when the display information control device 5 receives the user input information that includes the processing execution information transmitted from the user terminal 3, the display information control device 5 executes an update processing, which is illustrated in FIG. 18. The update processing will be described in detail below.

FIG. 18 is a flowchart that illustrates one example of the update processing. In the flowchart of the update processing that is illustrated in FIG. 18, in step S160, the priority update unit 16 first acquires the information of the user. Specifically, the priority update unit 16 acquires the information of the column of “person in charge” of the task information, in which the column of “task ID” of the task information included in the task information list 102 matches the information of the task ID of the acquired processing execution information.

In step S162, the priority update unit 16 next acquires the path information based on the acquired processing execution information and the process execution history list 106.

In step S164, the priority update unit 16 next acquires the display priority information based on the information of the user that is acquired in step S160, the path information that is acquired in step S162, and the display priority information list 105.

In step S166, the priority update unit 16 next creates the temporary display priority information based on the acquired processing execution information and the display priority information that is acquired step S164.

In step S168, the priority update unit 16 next updates the display priority information based on the display priority information that is acquired in step S164 and the temporary display priority information that is acquired in step S166 and finishes the update processing.

As described above, in this embodiment, in a case where the processing screen of a target task included in a workflow is displayed, a determination is made whether or not the target task is in an abnormal path based on the processing history information in which the task processing history of the workflow is accumulated. Further, in a case where the target task is in the abnormal path, the task processing information in which processing contents of the tasks in the workflow are accumulated is referred to with respect to each of the tasks from the task as the start point of the abnormal path in the workflow. Further, the display order of the displayed items that are displayed on the processing screen of the target task is controlled. Accordingly, the items on the processing screen of the task may be indicated in an appropriate display order in a case where the task is in an abnormal path.

Further, the screen configuration that is optimal for the task is automatically generated, and the cost in time that is requested for execution of the task and the development cost that is requested for screen design may thereby be reduced.

In this embodiment, a description has been made about a case where the rearrangement unit 13 uses only the display priority information that corresponds to the combination of the task in the transition source, the task in the transition destination, and the user and thereby acquires the pieces of input screen information that are arranged in the priority order. However, embodiments are not limited to this. For example, in a case where there is a path in which another task is provided as the task in the transition source of the transition to the task in the transition destination in the same process, the rearrangement unit 13 may acquire the pieces of input screen information that are arranged in the priority order in consideration of the other path. Specifically, the priority order that corresponds to each of the input item IDs in the display priority information which corresponds to the present path is added to the priority order that corresponds to each of the input item IDs in the display priority order which corresponds to the other path such that different weights are applied to the priority orders to be added together. The display priority information that is newly created from the value obtained by averaging the sum may be used. The weights may be set such that present path>the other path in a case where there are two paths. Further, in a case where there are three or more paths, the weights may be set such that present path>more frequently used path>the other path. Here, it is assumed that the more frequently used path may be acquired from the process execution history list. Further, the same applies to a case where the rearrangement unit 13 creates the screen configuration information. Any method other than the above methods may be used as long as the pieces of input screen information that are arranged in the priority order may be acquired by using statistical information.

Further, in this embodiment, a description has been made about a case where whether or not the path is an abnormal path is determined by determining whether or not the same task is called again. However, embodiments are not limited to this. For example, in a case where the task does not go through a predetermined path, a case where the task goes through a path whose frequency of use is low, or the like, the path may be determined as an abnormal path. Further, the path may be determined as an abnormal path in a case where the action content in the task in the transition source or in the task earlier than that is a content that is predetermined as the action content which indicates entrance of an abnormal path, or the like. The abnormality determination unit may realize a determination whether or not the task goes through a predetermined path, a determination whether or not the task goes through a path whose frequency of use is low, and a determination whether or not the action content in the task is a predetermined content, by using the process execution information. Further, the path whose frequency of use is low may be identified based on statistical information that uses the process execution information.

Further, in this embodiment, a description has been made about a case where data are retained in a retaining format that is a list format. However, embodiments are not limited to this. For example, another data retaining format such as a table may be used.

Further, in this embodiment, a description has been made about a case where the various lists are stored in the storage device. However, embodiments are not limited to this. For example, the various lists may be retained in an internal portion of the display information control device.

Further, in this embodiment, a description has been made about a case where the priority order is higher as the value of the priority order becomes smaller. However, embodiments are not limited to this. For example, the priority order may be set higher as the value of the priority order becomes larger.

Further, in this embodiment, a description has been made about a case where the priority update unit 16 updates the display priority information by the above method. However, embodiments are not limited to this. For example, the display priority information may be updated by another method.

Further, in a case where one task includes plural actions of variable update, the pieces of process execution information that correspond to the actions may be processed in an arbitrary order. Further, the process execution information in which the value of “history ID” is small (which is processed earlier) may be processed later.

Further, in a case where the display priority information is updated and where one task includes plural actions of variable update, the priority orders may be set to start from 1 such that the actions that are processed earlier have the higher priority orders, and the temporary display priority information may thereby be created. Here, in a case where the update history of the display priority information is retained and where the actions of variable update are sequentially performed in one task, the temporary display priority information is created by using the display priority information that is used to reflect the first action of variable update. Whether or not the actions of variable update are sequentially performed in one task may be determined based on the process execution history list.

Further, in the above, an embodiment is described in which each of the programs according to the techniques of the present disclosure is in advance stored (installed) in a storage device. However, embodiments are not limited to this. Each of the programs according to the techniques of the present disclosure may be provided in a form recorded in a recording medium such as CD-ROM, DVD-ROM, or USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium that stores a display information control program that causes a computer to execute a processing comprising:
displaying a plurality of display items corresponding to a first task based on a predetermined priorities for each of the plurality of display items when at least one task has been executed according to a predetermined order before an execution of the first task in a process, the first task and the at least one task being defined to be executed in the process;
determining a priorities for each of the plurality of display items when the at least one task has been executed according to an order different from the predetermined order before the execution of the first task in the process, the determining including making a priority for a specified display item to be higher than priorities for the plurality of display items for the first task other than the specified display item, the specified item being a display item accepting an input in the at least one task; and
displaying, after the determining, the plurality of display items corresponding to the first task based on the determined priorities.

2. The non-transitory computer-readable storage medium according to claim 1, wherein the priorities for each of the plurality of display items are determined based on term information that indicates a relationship between a term and the display item which is associated with the term and the processing contents.

3. The non-transitory computer-readable storage medium according to claim 1, wherein
the at least one task is a plurality of tasks defined to be executed in the process; and
the priorities for each of the plurality of display items are determined by repeating a processing in which a priority for a displayed item in a target task, among the plurality of tasks, is determined based on the processing contents of a task executed in the process before an execution of the target task, the target task is changed sequentially in the repeating from a task has been executed earliest among the plurality of tasks to a task has been executed latest among the plurality of tasks.

4. A display information control method comprising:
displaying a plurality of display items corresponding to a first task based on a predetermined priorities for each of the plurality of display items when at least one task has been executed according to a predetermined order before an execution of the first task in a process, the first task and the at least one task being defined to be executed in the process;
determining a priorities for each of the plurality of display items when the at least one task has been executed according to an order different from the predetermined order before the execution of the first task in the process, the determining including making a priority for a specified display item to be higher than priorities for the plurality of display items for the first task other than the specified display item, the specified item being a display item accepting an input in the at least one task; and
displaying, after the determining, the plurality of display items corresponding to the first task based on the determined priorities.

5. A display information control device comprising:
a memory; and
a processor configured to:
display a plurality of display items corresponding to a first task based on a predetermined priorities for each of the plurality of display items when at least one task has been executed according to a predetermined order before an execution of the first task in a process, the first task and the at least one task being defined to be executed in the process;
determine a priorities for each of the plurality of display items when the at least one task has been executed according to an order different from the predetermined order before the execution of the first task in the process, the determining including making a priority for a specified display item to be higher than priorities for the plurality of display items for the first task other than the specified display item, the specified item being a display item accepting an input in the at least one task; and
display, after the determining, the plurality of display items corresponding to the first task based on the determined priorities.
